(19) United States
(12) Patent Application Publication
(10) Pub. No.: US 2011/0106643 A1
(43) Pub. Date: May 5, 2011

(54) Systems and Methods for Electronic Summary and Detail Performance Data of Equipment Sellers

(76) Inventor: Ed BERKOWITZ, Redwood City, CA (US)

(21) Appl. No.: 12/892,590

(22) Filed: Sep. 28, 2010

Related U.S. Application Data
(60) Provisional application No. 61/246,471, filed on Sep. 28, 2009.

(51) Int. Cl. G06Q 30/00

(52) U.S. Cl. 705/26.3

(57) ABSTRACT

An auction server hosts an auction system on a network. An auction interface is provided for accessing the auction system. A buyer interface of the auction interface presents to buyers data of vehicles available for purchase. A seller interface presents to sellers data of vehicles available for purchase via the auction system. A first seller performance panel of the buyer interface includes first seller data of a seller corresponding to vehicles presented for purchase on the buyer interface. First seller data comprises performance data, successful sales data, adjusted sales data, and unwound sales data. A second seller performance panel of the seller interface includes second seller data of the seller. The second seller data comprises performance data of the seller for auction activities conducted by the seller. The second seller performance panel includes a management interface by which the seller manages components of the auction system.

### RELATED APPLICATIONS

This application claims the benefit of U.S. Patent Application No. 61/246,471, filed Sep. 28, 2009.

This application is related to U.S. patent application Ser. Nos. 11/457,068, 11/457,074, 11/457,077, 11/681,727, 11/681,729, 11/685,120, and 11/685,121.

### TECHNICAL FIELD

Embodiments are described relating to electronic auction systems and, more particularly, to summary and detail performance data of equipment sellers using the electronic auction systems.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of an electronic auction system that provides summary and performance data of sellers using the auction system, under an embodiment.

FIG. 2 is an example search results page with the Buyer Facing Seller Performance Panel, under an embodiment.

FIG. 3 is an example vehicle detail page of the Buyer Facing Seller Performance Panel, under an embodiment.

FIG. 4 is an example seller details page of the Buyer Facing Seller Performance Panel, under an embodiment.

FIG. 5 is an example of information presented under the adjusted sales tab and the successful sales tab of the Buyer Facing Seller Performance Panel seller details page, under an embodiment.

FIG. 6 is an example Seller Performance Panel, under an embodiment.

FIG. 7 is an example “UNITS LISTED FOR SALE” page of the Seller Performance Panel, under an embodiment.

FIG. 8 is an example “SUCCESS RATE” page of the Seller Performance Panel, under an embodiment.

FIG. 9 is an example “AMOUNT DUE OPENLANE” page of the Seller Performance Panel, under an embodiment.

FIG. 10 is an example showing grouping criteria for parameters of the Seller Performance Panel, under an embodiment.

FIG. 11 is an example grid plotting sellers according to title rate and void rate, under an embodiment.

FIG. 12 is an example grid plotting a distribution of sellers according to seller score, under an embodiment.

FIG. 13 is an example table showing a fee structure for sellers based on the Seller Performance Score, under an embodiment.

### DETAILED DESCRIPTION

In the following description, a number of features are described in detail in order to provide a more thorough understanding of the embodiments described herein. It is apparent that these embodiments may be practiced without these specific details. In other cases, well known features have not been described in detail.

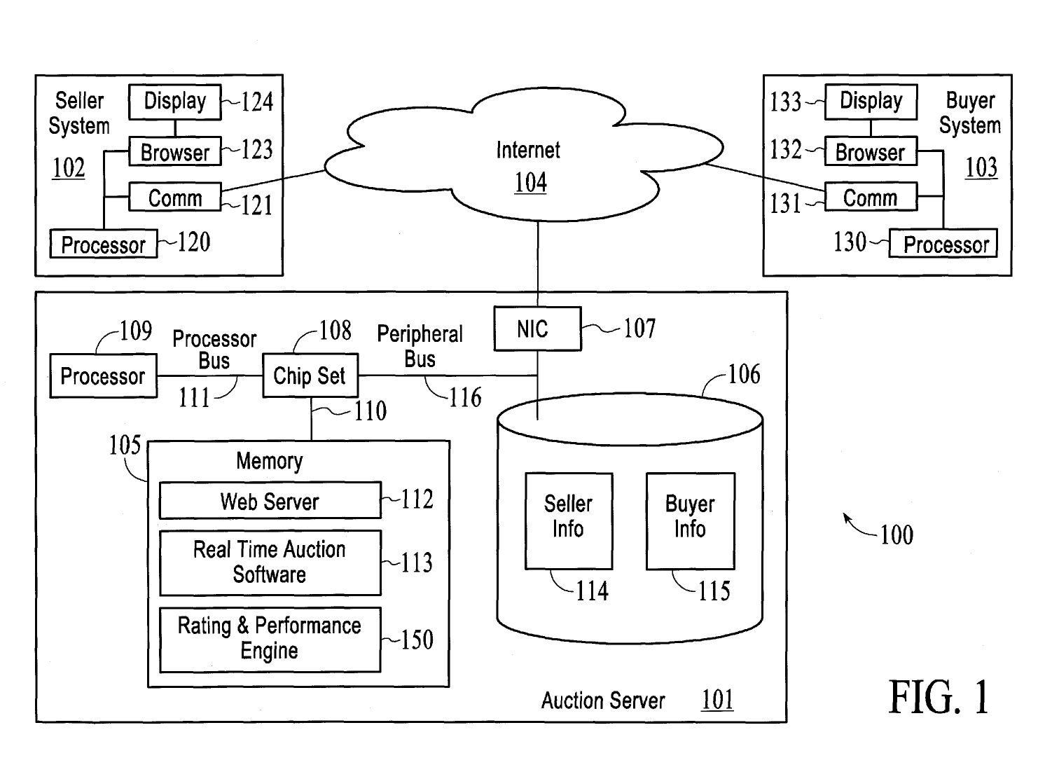

FIG. 1 is a block diagram of an electronic auction system 100 that provides summary and performance data of equipment sellers using the auction system 100, under an embodiment. The equipment of an embodiment includes motor vehicles, but the auction system 100 is not limited to motor vehicles. Other tools and network configurations may be used according to other embodiments. In the system 100 shown are auction server 101, seller system 102, and buyer system 103. Auction server 101 is coupled to seller system 102 and buyer system 103 through Internet 104. FIG. 100 shows a more detailed view of architecture of the various components of the auction system. Auction sever 101 may include a processor 109 for processing instructions, such as an Intel Pentium™ processor, AMD Athlon™ processor or other processor. Processor 109 is coupled to chip set 108 by a processor bus 111. Chip set 108 is coupled to memory 105 by a memory bus 110 and manages access to memory 105 by processor 109. Chip set 108 is also coupled to peripheral bus 116. Peripheral 116 bus can comprise, for example, PCI, PCI-X, PCI Express, or other peripheral bus. Auction server 101 also includes one or more network interface cards 107 coupled to peripheral bus 116 for providing network interfaces to network, such as Internet 104. Storage 106, such as a disk array or other non-voltage storage, is also coupled to peripheral bus 116.

According to various embodiments, memory 105 and/or storage 106 may include various forms of storage or computer-readable memories such as, but not limited to, volatile memory (random access memory (RAM), non-volatile memory (read-only memory (ROM)), EEPROM, disk, and/or other storage devices that may include one or more of magnetic, optical storage, or other media. The memory and/or storage on the auction server may be configured as a RAID (Redundant Array of Independent Disks) configuration to provide high reliability access to software and data.

Software may be loaded into memory 105 to help provide summary and detail performance data for auction server 101. For example, web server 112, real-time auction software 113, and the rating and performance engine 150 may be loaded into memory 105 and run by processor 109. Web server 112 provides web pages for the users to interact with in order to be provided with auction functions. For example, web server 112 may serve up web pages to seller system 102 and buyer system 103 in order to allow seller system 102 and buyer system 103 to access rating and performance information, as well as to view events and auction items to make bids and to participate in auctions. Storage 106 includes information about respective users, such as seller information 114 and buyer information 115. This information is used in order to determine or provide the rating and performance information, manage the inventory of items for sale, configuration of auction events, and the processing of real-time action functions. According to various embodiments, auction system 100 may include one or a plurality of auction servers 101 in various configurations and architectures to provide auctions and bidding functionality.

Seller system 102 and/or buyer system 103 may comprise computer systems coupled to a network such as Internet 104 according to an embodiment. As shown, seller system 102 includes processor 120 and software components such as browser 123 and communications software 121. Also included is a display 124 that allows a user to access and view rating and performance information as well as information regarding auctions and to perform related administration. Buyer system 103 also includes a processor 130, communication software 131, browser 132, and display 133. Various browser software or other software or functionality to provide user interaction may be used in buyer and seller systems. For example, browsers may include, but are not limited to, Internet Explorer, Netscape browser, Firefox browser, Safari browser or other browser. Alternatively, other user interface software not including a browser may be used.

Software such as web server 112, real-time auction software 113, and rating and performance engine 150 may be stored in storage 106 or other storage and may be loaded into memory 105 for manipulation by processor 109 according to an embodiment. Portions of data such as seller information 114 and buyer information 115 may be loaded into data structures in memory 105 or other storage for manipulation by processor 109 in accordance with software such as web server 112, real-time auction software 113, and the rating and performance engine 150. Web server 112 includes an operating system for managing system resources, such as Microsoft Windows XP, 2000, 98, or NT, Apple OS, Linux, or other operating systems as well as applications software running on top of the operating systems for implementing an HTML server or other server. Information stored in storage 106 may be stored in various forms of database arrangements and may contain cross references or links to one another to allow information to be queried and retrieved. In an example embodiment, the information is stored in databases, such as relational databases, and may be queried using structured query language (SQL) or other mechanism. The system may include a secure connection or connections. For example, in an embodiment, the entire bidding operation of the system operates on a secure connection or connections. Various different technologies may be used to provide a secure connection, such as encryption with, for example, public key and private key encryption. The system may be set up over a virtual private network (VPN).

In an example embodiment, a seller operates seller system 102 through browser 123, communications software 121, and display 124 to set up seller inventory and seller events in seller information storage 114. The seller-user also manages the events and bidding through seller system 102, which communicates via Internet 104 with web server 112.

Buyer system 103 interacts with a buyer user, allowing the buyer user to view summary and detail performance data as well as items and events including the items for auction. The interaction is provided to the buyer user through display 133, browser 132, and communications software 131, which are controlled by processor 130. Buyer system in turn communicates with auction server 101 via Internet 104. Web server 112 in turn provides buyer system 103 with graphical interface pages which may be displayed on display 133. Components and functions of the electronic auction system 100 are described further in the Related Applications described above.

The rating and performance engine 150 of the auction system 100 of an embodiment provides and enables the summary and detail performance data system. The summary and detail performance data system of an embodiment includes a Buyer Facing Seller Performance Panel and a Seller Performance Panel, each of which is described in detail below. The summary and detail performance data system uses data derived from all OPENLANE auction activities conducted using the electronic auction systems, but is not so limited.

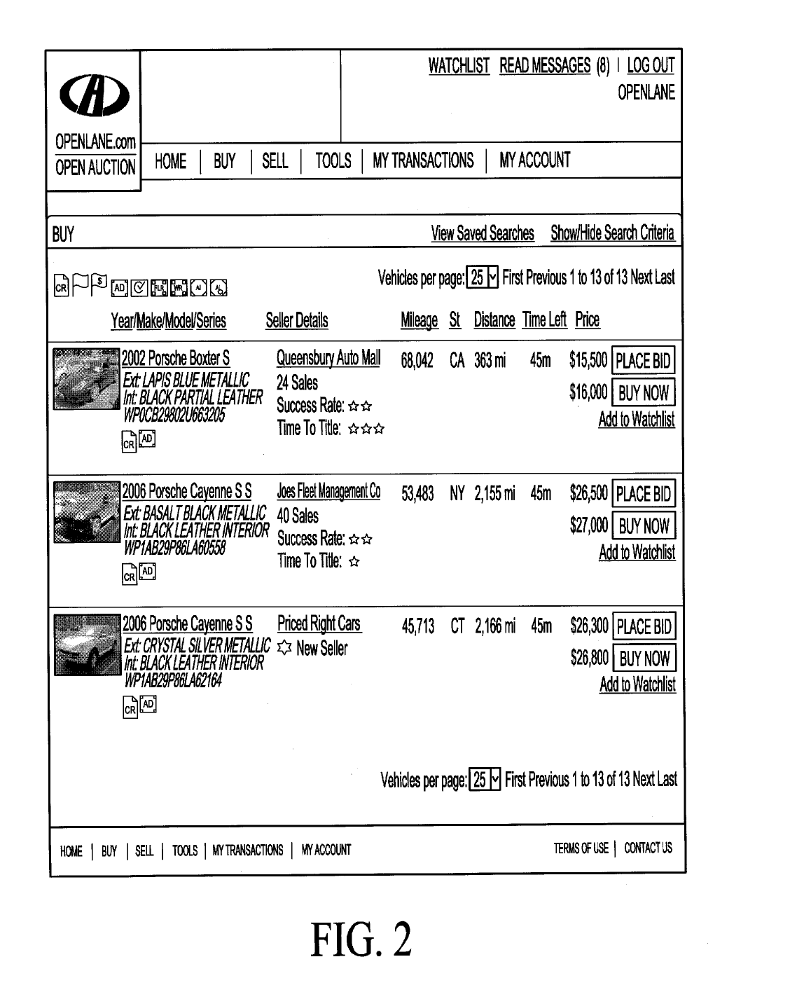

FIG. 2 is an example search results page of the Buyer Facing Seller Performance Panel, under an embodiment. The search results page presents, for example, vehicle information for vehicles available for purchase in response to some search criteria along with details of the seller of each vehicle. The seller (e.g., a new and/or used car dealership, an institutional seller, any business licensed for auto wholesale, etc.) name displayed on this page links to a seller marketing page that enables the seller to effectively market their organization. In order for the performance stars to be displayed in an embodiment, the organization should have the “Present Seller Performance Stars to Buyers” flag set to yes. In order for any performance statistics to be displayed in an embodiment, the organization should have the “Present Seller Performance Details to Buyers” flag set to yes.

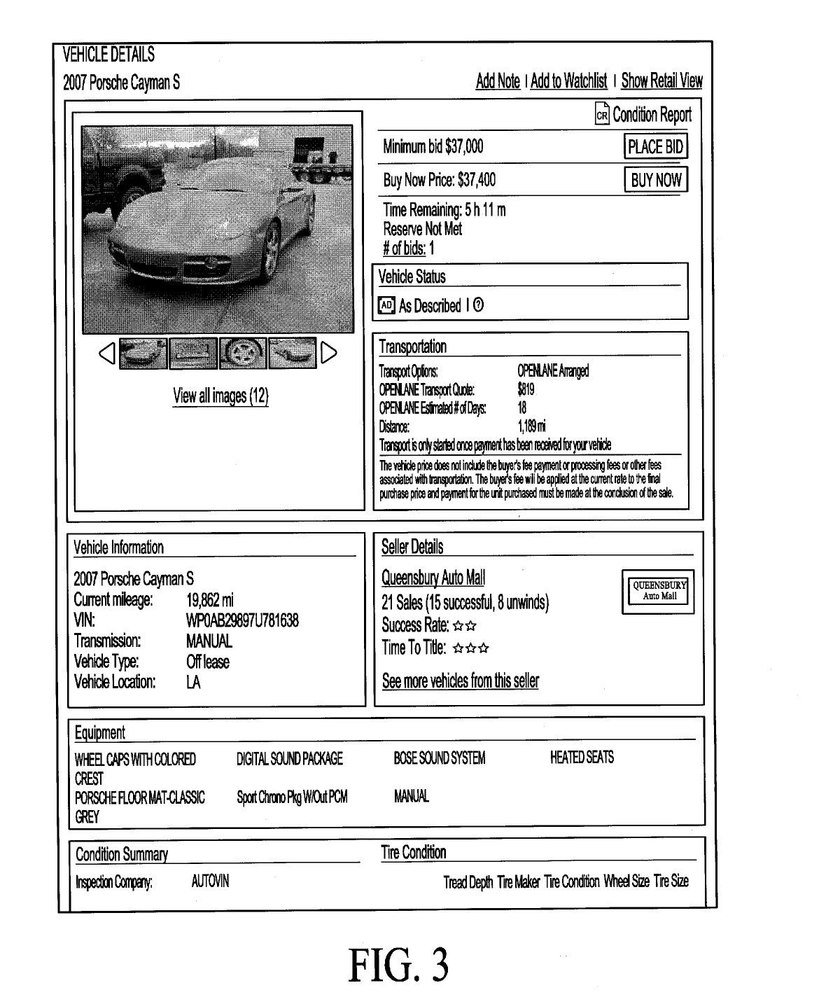

FIG. 3 is an example vehicle detail page of the Buyer Facing Seller Performance Panel, under an embodiment. The vehicle detail page is presented in response to selecting or clicking on a particular vehicle presented on the search results page (FIG. 2), and presents, for example, detailed vehicle information along with details of the seller corresponding to the presented vehicle. The seller name displayed on this page links to a seller marketing page that includes seller information including, but not limited to, seller marketing information, logo, and/or performance details. The seller details presented on the vehicle detail page include information of number of sales, success rate, and time to title, but the embodiment is not so limited. In order for the performance stars to be displayed in an embodiment, the organization should have the “Present Seller Performance Stars to Buyers” flag set to yes and for any seller performance statistics to display in an embodiment, the organization should have the “Present Seller Performance Details to Buyers” flag set to yes.

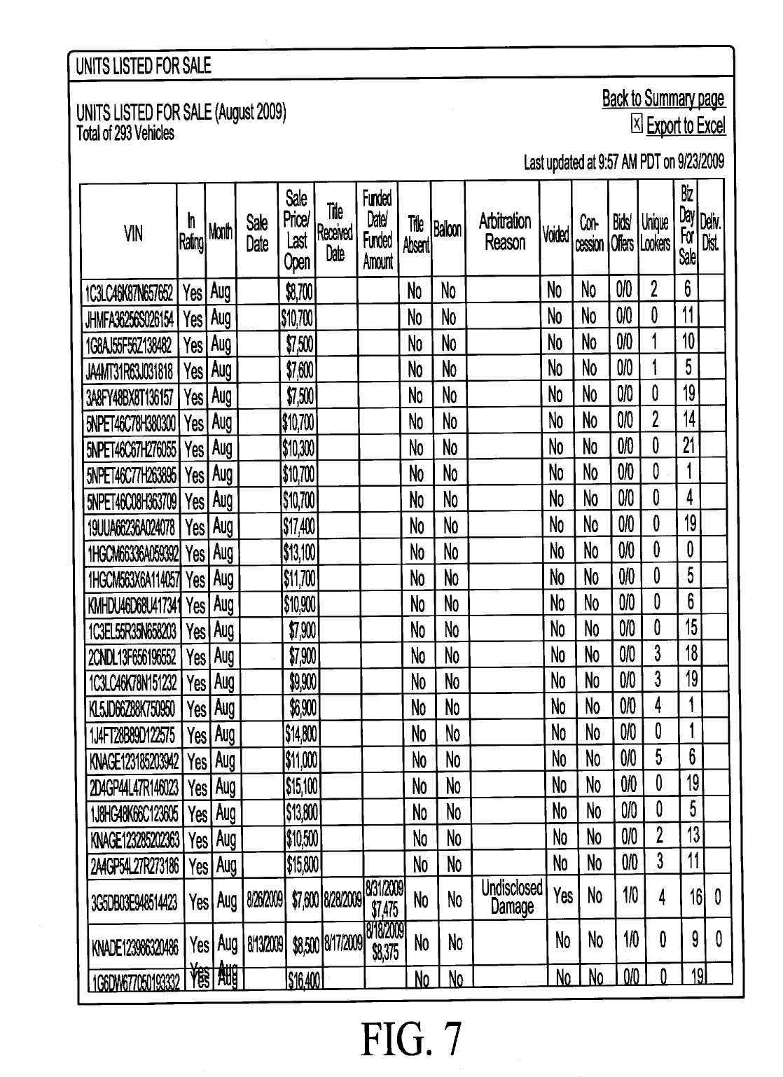

Success rate is determined according to the following formula: (total sales ‘minus’ unwound sales that are the sellers fault ‘minus’ vehicles with “in rating” equals no) divided by (total sales ‘minus’ vehicles with “in rating” equals no). Calculations of the success rate include in total sales all units sold (arbitrated or unwound) (see FIG. 7 and the corresponding description below). Furthermore, unwound transactions are defined by case resolutions of “Buy Back/Void” or “House Void”, and where case reasons are not the fault of the seller including but not limited to “Listing Error-OPENLANE fault”, “Transport Issue”, or “Buyer Purchased in Error”. A case resolution corresponds to a “case,” which is defined in an embodiment as an issue with a sale that is created in response to a buyer complaint or seller notification of a problem with the vehicle at issue. The categories of success rate for a seller are based on the following tiers, but the embodiment is not so limited: three (3) stars indicate a success rate at or above 95%; two (2) stars indicate a success rate between 85 and 95%; one (1) star indicates a success rate at or less than 85%. In determining these statistics, successful sales are non-adjusted, non-unwound sales where unwound sales are vehicles that were voided, and adjusted sales are vehicles with a concession granted to the buyer.

Time to title information is based on the average time to OPENLANE's receipt of title from seller, where the tile can be transferred in to the buyer's name (referred to herein as “transferable title”). In an embodiment, average time to transferable title is the total number of business days between the vehicle sale date and receipt of transferable title, where the vehicle sale date is defined as day zero. The average time to title is calculated as the number of business days from “SALE_DATE” to “CLEAN_TITLE_IN_DATE” excluding holidays. The “title in date” is defined as follows, but is not so limited: if there was no title problem (per the problem title queue), the title received date is the title in date; if there was a title problem, the title issue resolved date is the title in date; if a title has not yet been received and it has been more than five (5) days from sale, the number of days is calculated from the sale date to present and this number of days is used to calculate the title in date but is not so required. Time to title information of an embodiment includes information of non-title absent (T/A), non-balloon vehicles and separately T/A or balloon vehicles.

Non-title absent (T/A), non-balloon represents vehicles where “title absent” or a vehicle type of “retail balloon” were not selected during the listing process. The categories for measuring a seller on time to title of non-T/A, non-balloon vehicles are based on the following tiers: three (3) stars indicate a transferable title was furnished in an average of five (5) days or less; two (2) stars indicate a transferable title was furnished in an average of between five (5) and 10 days; and one (1) star indicates a transferable title was furnished in an average of 10 days or more. A Totals column is the average time to transferable title for the past six (6) months.

Title Absent or balloon note represents vehicles where “title absent” or a vehicle type of “retail balloon” was selected during the listing process. The categories for measuring a seller on time to title of T/A or balloon vehicles are based on the following tiers: three (3) stars indicate a transferable title was furnished in an average of 15 days or less; two (2) stars indicate a transferable title was furnished in an average of between 15 and 25 days; and one (1) star indicates a transferable title was furnished in an average of 25 days or more. A Totals column is the average time to transferable title for the past six (6) months.

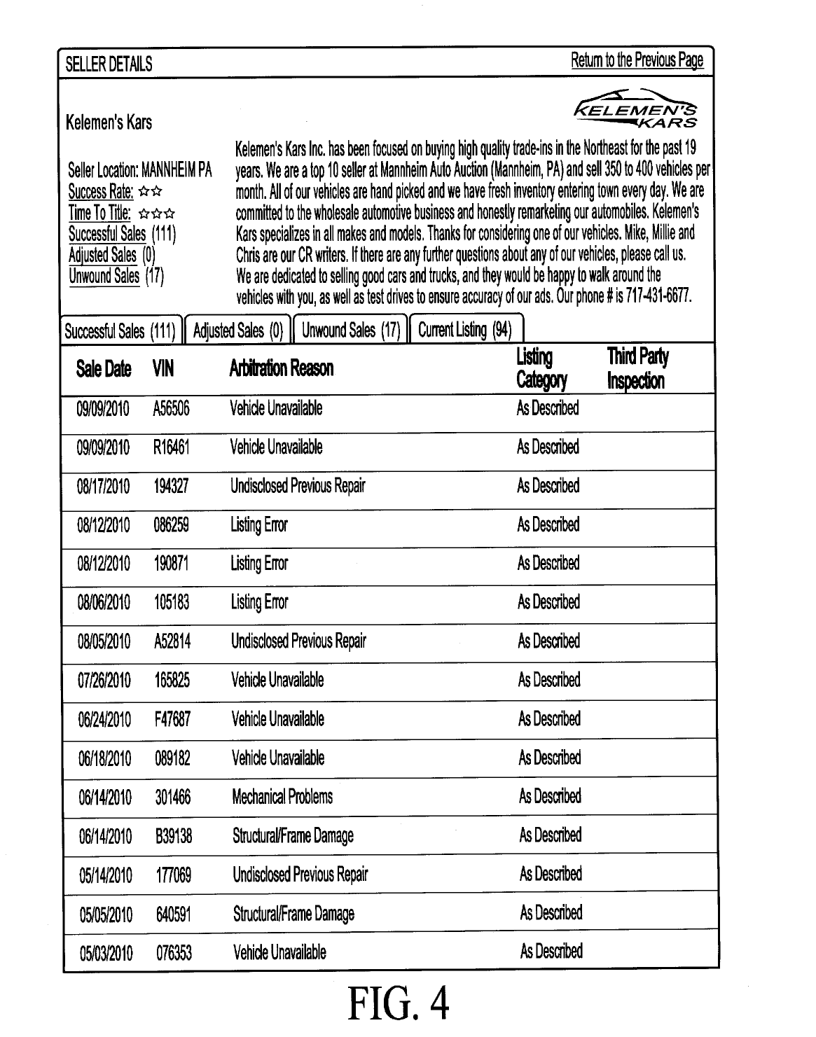

FIG. 4 is an example seller details page of the Buyer Facing Seller Performance Panel, under an embodiment. The seller details page is presented in response to selecting or clicking on the seller name presented on the search results page or the vehicle detail page, and presents, for example, numerous dates under which specific details of a seller are presented but the embodiment is not so limited. In an embodiment, the seller details page includes a tab for successful sales information, a tab for adjusted sales details (with the case reason provided from an external or other coupled system, for example, but the embodiment is not so limited), a tab for unwound sales details (with the case reason provided from an external or other coupled system, for example, but the embodiment is not so limited), and a tab for current listings. The seller details page of an embodiment also captures and presents information of whether a third party inspection was performed on the vehicle, which would at least inform the buyer that the seller was not trying to be deceptive. Using this example page, which displays contents of the unwound sales tab, the information presented for each unwound vehicle sale includes the sale data, vehicle identification number, and arbitration reason but is not so limited.

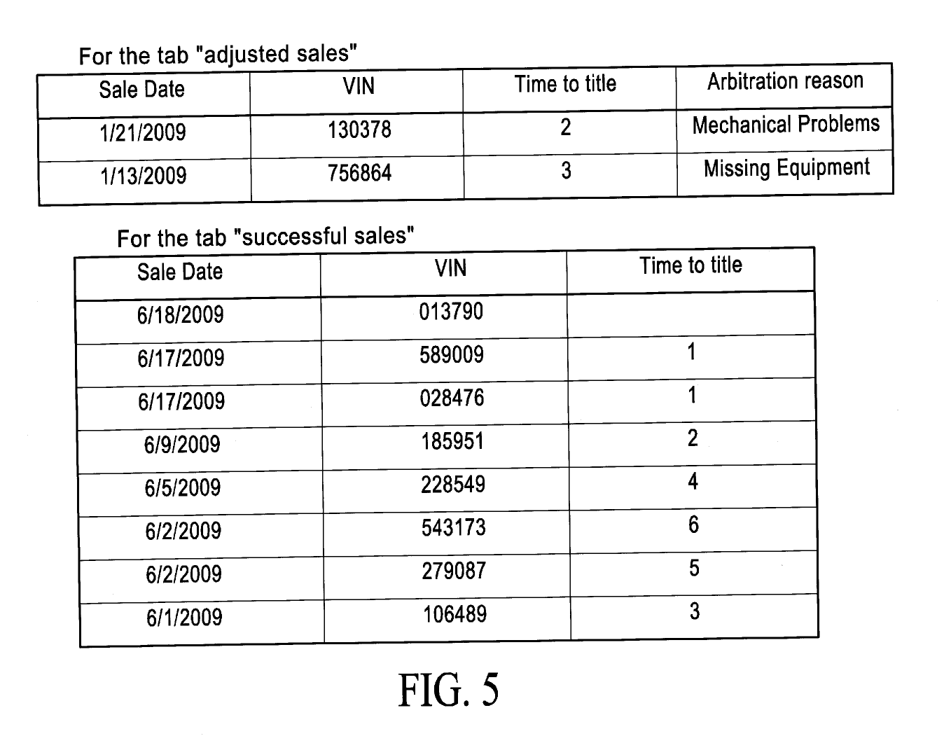

FIG. 5 is an example of information presented under the adjusted sales tab and the successful sales tab of the Buyer Facing Seller Performance Panel seller details page, under an embodiment. Using this example, the displayed contents of the adjusted sales tab presents information for each adjusted vehicle sale, the information including the sale date, vehicle identification number, time to title, and arbitration reason. The displayed contents of the successful sales tab presents information for each successful vehicle sale that includes the sale date, vehicle identification number, and time to title but is not so limited.

In addition to the Buyer Facing Seller Performance Panel, the summary and detail performance data system of an embodiment includes a Seller Performance Panel. The Seller Performance Panel presents summary and detail performance data derived from all OPENLANE auction activities conducted using the electronic auction system described above, but is not so limited. In order for the seller performance panel to display in an embodiment, the organization should have an “Enable Seller Performance” flag set to yes. In order for the performance stars to display in an embodiment, the organization should have an “Enable Performance Stars” flag set to yes.

The system of an embodiment measures seller performance based on any one or combination of statistical data derived from the auction process. The seller performance of an embodiment, for example, can include one or more of the following statistics, but the embodiment is not so limited: total listings as an indicator of seller wholesale process; total sales (displaying actual number of sales) as an indicator of experience with the process; sales rate as an indicator of seller pricing quality; average time to title as an indicator of seller process quality; title problems as an indicator of seller process quality; unwind rate as an indicator of buyer experience; buyer feedback as an indicator of the buyer perspective; concession rate as an indicator of seller listing quality.

Concession rate is calculated as vehicles for which financial remuneration was offered to the buyer due to a problem with some aspect of the transaction (that is the seller's fault) divided by total sales. Calculations of the concession rate include in total sales all units sold (vehicles with a concession or unwinds) except those that have “No” in the “In Rating” column (see FIG. 7 and the corresponding description below). Furthermore, concessions are defined by a case resolution type of “Concession”, where case reasons are not the fault of the seller and include but are not limited to “Technology Error-OPENLANE fault”, “Transport Issue”, or “Undisclosed Damage—Third Party Inspection Company”. Finally, a vehicle cannot have a concession if the vehicle was also unwound.

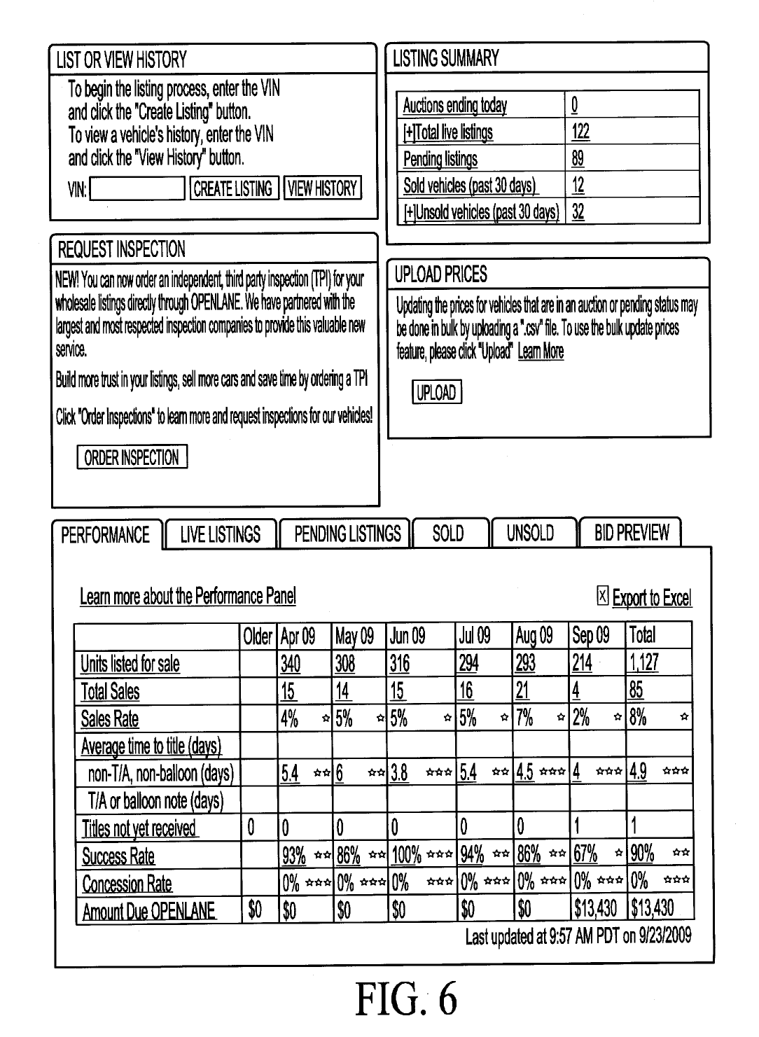

FIG. 6 is an example Seller Performance Panel, under an embodiment. The Seller Performance Panel of this example is the tab sellers use to understand their performance on OPENLANE. Sellers also have day to day activities they perform on OPENLANE, and the other seller tabs are used to manage their listings, sales, pending listings, unsold vehicles, and review bids on existing units, to name a few, but the embodiment is not so limited.

The units listed for sale for each individual month represents the number of unique vehicles made available for sale on any auction system site in that month. For the total column, the number presented represents the sum of the unique vehicles made available for sale on any auction system site for the six (6) month window. The total column will generally be less than the sum of the individual months because VINs are often listed in multiple months.

The total sales for each individual month represent the number of units sold on any auction system site in that month. For the total column, the number presented represents the total units sold on any auction system site for the six (6) month window.

The sales rate presented for each individual month represents the number of units sold on any OPENLANE auction system site of an embodiment in that month divided by the number of unique vehicles made available for sale on any OPENLANE auction system site in that month. For the total column, the number presented represents the sum of the units sold on any OPENLANE auction site for the six (6) month window divided by the unique vehicles made available for sale on any OPENLANE auction site for the six (6) month window. The star performance for sales rate are based on the following tiers, but the embodiment is not so limited: three (3) stars indicate a sales rate greater than approximately 40%; two (2) stars indicate a sales rate approximately in a range of 10-40%; one (1) star indicates a sales rate less than approximately 10%.

The average time to title (days) presented for individual months represents, for all sales in the month, the average number of business days between receipt of transferable title and the sale date, where the vehicle sale date is day zero. For the total column the number presented represents, for all sales, the average number of business days between receipt of transferable title and the sale date, where the vehicle sale date is day zero. The performance for a seller for time to title of non-T/A, non-balloon vehicles (the average time to title for those vehicles not listed as “title absent” or “retail balloon” units) are based on the following tiers, but the embodiment is not so limited: three (3) stars indicate a transferable title was received, on average, in five (5) days or less from sale; two (2) stars indicate a transferable title was received, on average, between five (5) and 10 days from sale; and one (1) star indicates a transferable title was received, on average, in more than 10 days from sale. The performance for a seller for time to title of T/A or balloon vehicles (the average time to title for those vehicles listed as “title absent” or “retail balloon” units) are based on the following tiers, but the embodiment is not so limited: three (3) stars indicate a transferable title was received, on average, in 15 days or less from sale; two (2) stars indicate a transferable title was received, on average, between 15 and 25 days from sale; one (1) star indicates a transferable title was received, on average, in more than 25 days from sale.

The titles not yet received presented for individual months represents, for all sales in the month, the count of titles not yet received, or titles received that are not yet transferable. The “older” titles not yet received presented represents, for sales in months prior to the six (6) months displayed, the titles not yet received, or titles received that are not yet transferable. The number presented in the total column represents all titles not yet received, or titles received that are not yet transferable. Vehicles that are voided are not included in this count.

The success rate presented for individual months represents the number of units that sold and were not unwound (or voided) on any auction system site in that month (total sales ‘minus’ unwound sales that are the sellers fault ‘minus’ vehicles with “in rating” equals no) divided by the number of units sold on any auction system site in that month (total sales ‘minus’ vehicles with “in rating” equals no). For the total column, the number presented represents the number of units that sold and were not unwound (or voided) on any auction system site in the six (6) month window divided by the number of units sold on any auction system site in the six (6) month window. The success rate is based on the following tiers, but the embodiment is not so limited: three (3) stars indicate a success rate at or above 95%; two (2) stars indicate a success rate between 85 and 95%; one (1) star indicates a success rate at or below 85%.

The concession rate presented for individual months represents the number of units for which a concession was paid to the buyer where the source of the concession was attributable to the seller (except those that have “No” in the vehicles with “in rating” equals no) divided the number of units sold on any auction system site in that month. For the total column, the number presented represents the number of units for which a concession was paid to the buyer that was attributable to the seller divided the number of units sold on any auction system site in the six (6) month window. Unwinds/voids are not included in the concession rate calculation to prevent double penalty. The concession rate is based on the following tiers, but the embodiment is not so limited: three (3) stars indicate 5% or less of sales had a concession paid; two (2) stars indicate between 5 and 15% of sales had a concession paid; one (1) star indicates 15% or more of sales had a concession paid.

The amount due OPENLANE (also referred to herein as Accounts Receivable (AIR)) presented for individual months represents the sum of all outstanding invoices created in that month which are owed to OPENLANE and remain unpaid, for all transactions types including purchases, transportation, sales fees, arbitration outcomes and more. The number presented for “older” represents, for invoices created in months prior to the six (6) months explicitly displayed, the sum of all outstanding invoices which are owed to OPENLANE, remain unpaid, and represents all transactions types including purchases, transportation, sales fees, arbitration outcomes and more. The number presented for the total column represents the total of all outstanding invoices which are owed to OPENLANE and remain unpaid for all transactions types including purchases, transportation, sales fees, arbitration outcomes and more. For all cases, the invoice creation date is day zero. An additional but not pictured star performance for A/R informs sellers of their payment performance of OPENLANE invoices. The performance is based on the following tiers, but the embodiment is not so limited: three (3) stars indicate for all invoices created in that month that the accounts receivable was settled in 20 days or less; two (2) stars indicate for all invoices created in that month that the accounts receivable was settled in more than 20 but fewer than 45 days; one (1) stars indicate for all invoices created in that month that the accounts receivable was settled in 45 days or more.

FIG. 7 is an example “UNITS LISTED FOR SALE” page of the Seller Performance Panel, under an embodiment. The “UNITS LISTED FOR SALE” page of this example (August 2009) is displayed in response to the user selecting or clicking the “293” link (number of units listed for sale in August 2009) in the row “Units listed for sale” and the column “August 2009” under the performance tab of the Seller Performance Panel (FIG. 6).

Numerous parameters are presented on the UNITS LISTED FOR SALE page of the Seller Performance Panel but the embodiment is not limited to these parameters. The parameters presented in an example embodiment are described below. The VIN is the vehicle identification number. The In Rating represents whether this VIN was excluded from the sellers performance statistics, which would be used extremely rarely to withhold a transaction from the seller's entire Seller Performance Panel metrics. The Month represents the month in which the unit was at auction (based on auction end date); many VINs can appear in multiple months. The Sale Date represents the date on which the vehicle sold. Sale Price/Last Open represents the price at which the vehicle sold, if the vehicle sold; if the vehicle did not sell, the number presented represents the last open price. Title Received Date represents the receipt date of the title, if there was no title problem (per the problem title table), and represents the date the title issue was resolved when there was a title problem; if a title has not yet been received and it has been more than three (3) days from sale, the number of days from sale to today is calculated and used in a calculation of “title received date”. The Funded Date represents the date the seller was funded for sale, and the Funded Amount represents the amount funded on the “funded date”. Title Absent represents if the T/A flag was set at time of listing. The Balloon flag indicates is the vehicle type is a retail balloon which was set at time of listing.

The Arbitration Reason represents the reason for arbitration. An embodiment includes as arbitration reasons case resolutions of “Frame Damage”, “Mechanical Problems”, “Missing Equipment”, “Odometer Discrepancy”, “Poor Previous Repair”, “Title Issues/Title Not Available”, “Transport Damage”, “Undisclosed Damage”, “Undisclosed Previous Repair”, and “Vehicle Not Available”. An embodiment does not include as arbitration reasons case resolutions of “decline/return to workflow” or “Decline”, “Listing Error-Pricing”, “Sales Goodwill-Buy Side”, “Transport Issue”. If the transaction was arbitrated but not the Sellers fault, the Arbitration Reason will state “Seller Not At Fault” but the unit will continue to be shown as an arbitrated vehicle, and the seller will not be penalized in the Success Rate or Concession Rate calculations.

Voided represents whether or not the sales transaction was unwound. An embodiment represents as an unwound transaction case resolutions of “Buy Back/Void” or “House Void”. If the seller is not at fault, this “unwind” will not negatively affect the sellers success rate calculation.

Concession represents whether or not the sales transaction had some financial remuneration to the buyer by the seller. An embodiment represents as a concession case resolutions of “Concession”. If the seller is not at fault, this “concession” will not negatively affect the sellers concession rate calculation.

Bids represents a number of bids placed across all iterations in the month, regardless of if the vehicle sells or not (i.e., if the bid does not cross the original or adjusted reserve). Offers represents a number of unique offers submitted via the “Submit Best Offer” method presented to buyers for each particular VIN.

Unique lookers represent a number of unique buyers looking at the vehicle for the given month (e.g., if a vehicle is listed for 2 months, and the same buyer looks in both months, each month he would be counted as just one unique looker) where the looker is a licensed dealer and not an institution. The Biz Day For Sale represents a number of days for which the vehicle was actually at auction. Delivery distance represents the distance between the vehicle location and the buyer location (this is captured and used to determine the reach OPENLANE provides to sellers).

Additional line items will be added to further drive workflow and seller performance. Additions include adding “open cases” where sellers can view and interaction with all open cases they have on either their sales or their purchases; ability to create new cases on the OPENLANE customer service portal; and more.

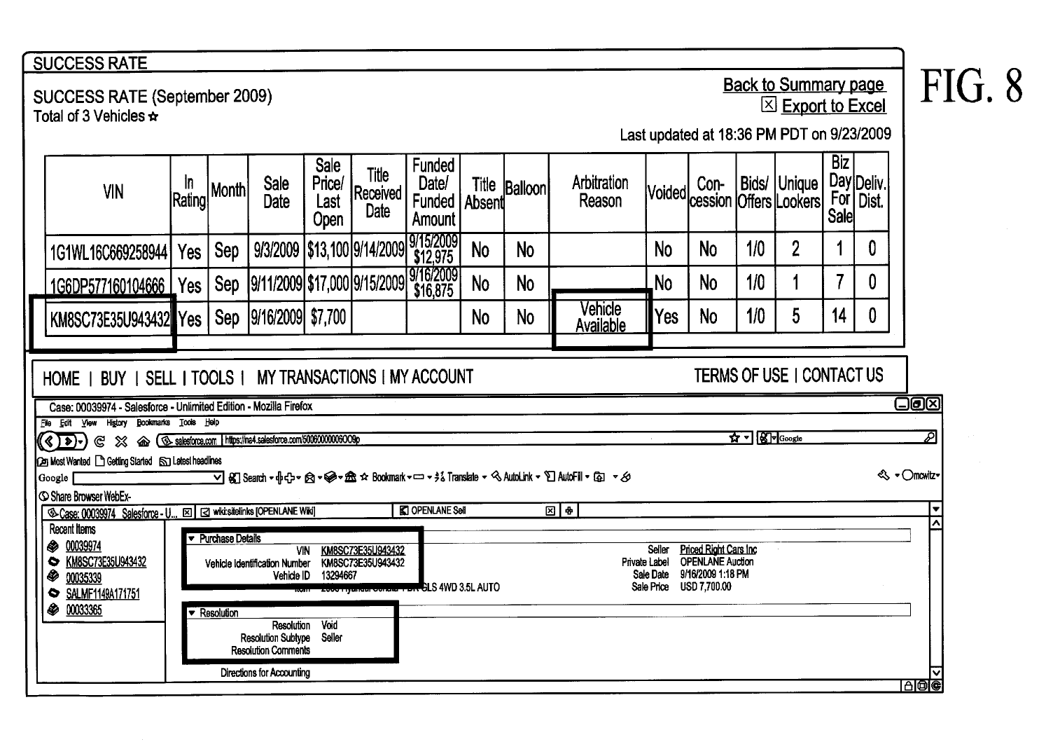

FIG. 8 is an example “SUCCESS RATE” page of the Seller Performance Panel, under an embodiment. The “SUCCESS RATE” page is displayed in response to the user selecting or clicking the “100%” link (success rate for September 2009) in the row “Success Rate” and the column “Sep 09” under the performance tab of the Seller Performance Panel. The “arbitration reason” is actually determined and captured in another system (in this particular case, SalesForce), and is brought over to the Seller Performance Panel to provide clear visibility to sellers as to the issues on their particular vehicles. In an embodiment, a user can select or click on a VIN presented on this page, and selection of a particular VIN couples or connects the user (e.g., via a web browser or external or other coupled system, for example, but the embodiment is not so limited) to additional information of a transaction corresponding to the selected YIN. In this example, the additional information presented pertaining to the transaction includes SalesForce information including the resolution of an arbitration, but any information can be presented.

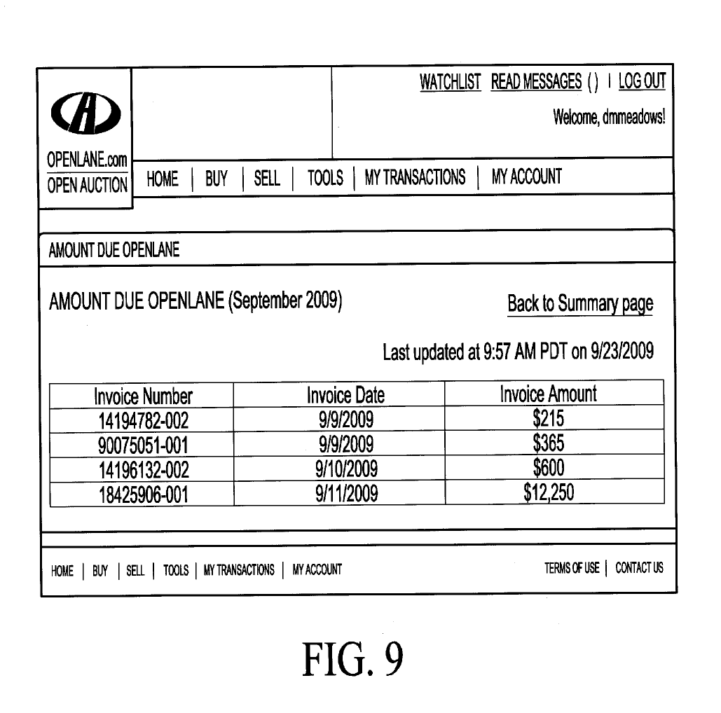

FIG. 9 is an example “AMOUNT DUE OPENLANE” page of the Seller Performance Panel, under an embodiment. The “AMOUNT DUE OPENLANE” page is displayed in response to the user selecting or clicking the “$42,030” link (amount due for September 2009) in the row “Amount Due OPENLANE” and the column “September 2009” under the performance tab of the Seller Performance Panel. A user can select an invoice number from this page, and selection of a particular invoice number causes that specific invoice from the Enterprise Relationship System (SAP) to be displayed. The “AMOUNT DUE OPENLANE” page of the Seller Performance Panel of an embodiment can include a link to one or more external systems, where the link enables a seller to create a new “case” to get answers to questions about their invoices and/or request a copy of an invoice in case they cannot generate on their own.

The Seller Performance Panel of an embodiment includes a variety of information, as described in detail above. This information includes, but is not limited to, units listed for sale, total sales, sales rate, average time to transferable title (non-T/A, non-balloon), average time to transferable title (T/A or balloon note), titles currently outstanding, success rate, concession rate, and outstanding A/R.

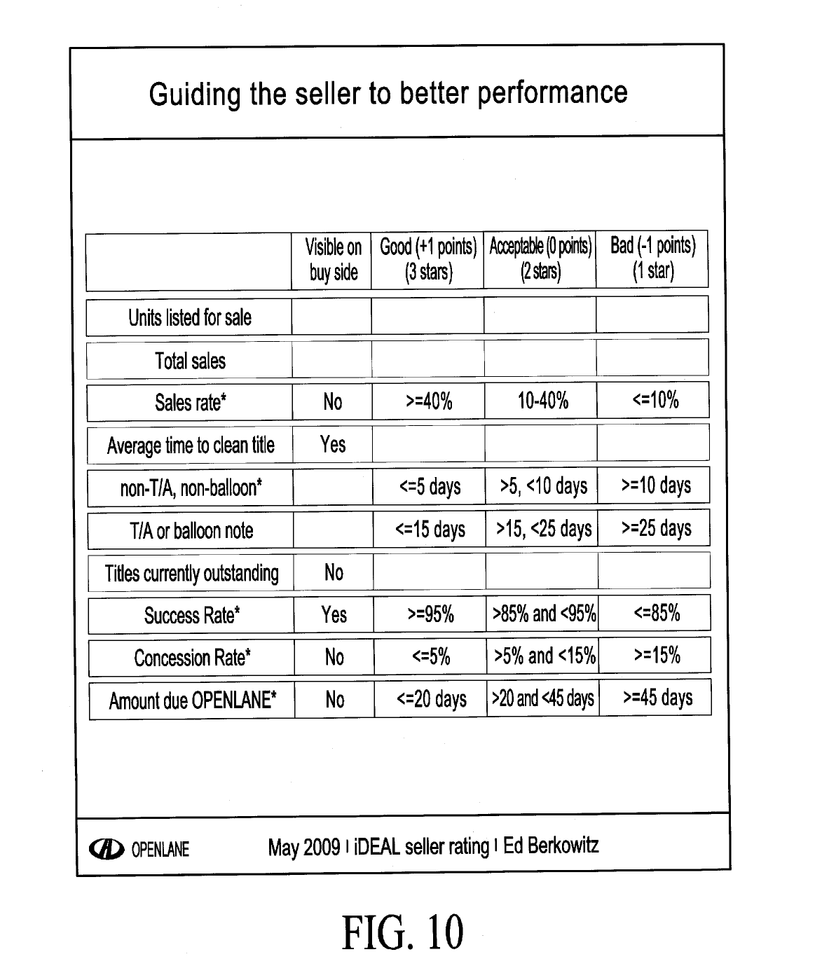

FIG. 10 is an example showing performance criteria for parameters of the Seller Performance Panel, under an embodiment. The performance criteria is shown for each of sales rate, average time to transferable title (non-T/A, non-balloon), average time to transferable title (T/A or balloon note), success rate, concession rate, and Amount due OPENLANE, each of which is described in detail above, but the embodiment is not limited to these parameters. In addition to the performance criteria an embodiment uses the performance for each of sales rate, average time to transferable title (non-T/A, non-balloon), average time to transferable title (T/A or balloon note), success rate, concession rate, and Amount due OPENLANE to determine or calculate a seller's “score” across these five dimensions. The score is calculated for a seller using a point system that credits the seller with one (1) point for a three-star performance, zero points for a two-star performance, and minus one point for a one-star performance.

Using the performance and scoring criteria described above, the sales rate performance and the score for each tier are as follows, but the embodiment is not so limited. Three (3) stars indicate a sales rate greater than approximately 40%, and corresponds to a score of +1 point. Two (2) stars indicate a sales rate approximately in a range of 10%-40%, and corresponds to a score of zero (0) point. One (1) star indicates a sales rate less than approximately 10%, and corresponds to a score of −1 point.

The performance for a seller for time to transferable title of non-T/A, non-balloon vehicles (the average time to title for those vehicles not listed as “title absent” or “retail balloon” units) along with the score for each performance tier are as follows, but the embodiment is not so limited. Three (3) stars indicate a transferable title was received, on average, in 5 days or less from sale, and correspond to a score of +1 point. Two (2) stars indicate a transferable title was received, on average, between 5 and 10 days from sale, and correspond to a score of zero (0) point. One (1) star indicates a transferable title was received, on average, in more than 10 days from sale, and corresponds to a score of −1 point.

The performance for a seller for time to title of T/A or balloon vehicles (the average time to title for those vehicles listed as “title absent” or “retail balloon” units) along with the score for each performance tier are as follows, but the embodiment is not so limited. Three (3) stars indicate a transferable title was received, on average, in 15 days or less from sale, and correspond to a score of +1 point. Two (2) stars indicate a transferable title was received, on average, between 15 and 25 days from sale, and correspond to a score of zero (0) point. One (1) star indicates a transferable title was received, on average, in more than 25 days from sale, and corresponds to a score of −1 point.

The success rate for a seller along with the score for each performance tier is as follows, but the embodiment is not so limited. Three (3) stars indicate a success rate at or above 95%, and correspond to a score of +1 point. Two (2) stars indicate a success rate between 85 and 95%, and correspond to a score of zero (0) point. One (1) star indicates a success rate at or less than 85%, and corresponds to a score of −1 point.

The performance for concession rate for a seller along with the score for each tier is as follows, but the embodiment is not so limited. Three (3) stars indicate 5% or less of sales had a concession paid, and correspond to a score of +1 point; two (2) stars indicate between 5 and 15% of sales had a concession paid, and correspond to a score of zero (0) point; 1 star indicates 15% or more of sales had a concession paid, and corresponds to a score of −1 point.

The amount due OPENLANE (also referred to herein as Accounts Receivable (A/R)) performance for a seller along with the score for each performance tier is as follows, but the embodiment is not so limited. Three (3) stars indicate accounts receivable settled in 20 days or less, and correspond to a score of +1 point. Two (2) stars indicate accounts receivable settled in more than 20 but fewer than 45 days, and correspond to a score of zero (0) point. One (1) star indicates accounts receivable settled in 45 days or more, and corresponds to a score of −1 point.

The star tiers in the areas of void rate (which equals 1—success rate, which is defined above) and title rate are used in an embodiment to group the sellers. This information of seller distribution is presented to the buyers using a grid or plot, but is not limited to this display type.

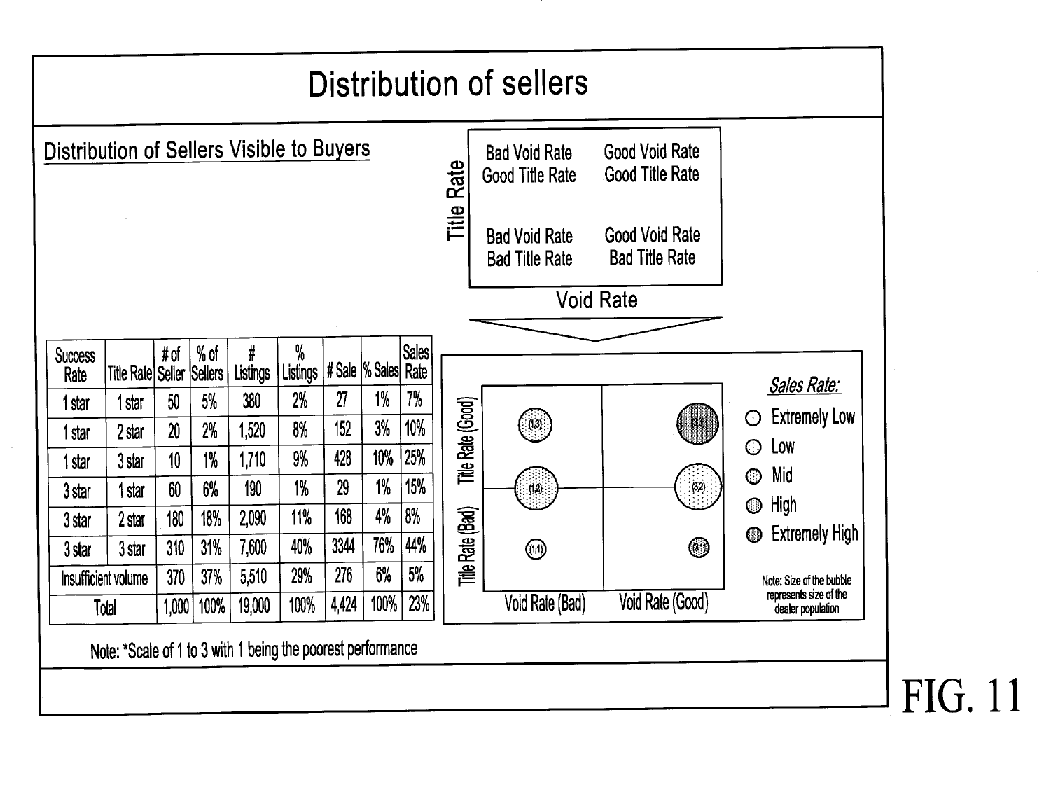

FIG. 11 is an example grid plotting sellers according to title rate and void rate, under an embodiment. The grid of this example generally includes four sectors or regions. A first sector of the example grid corresponds to a bad void rate (1 star) and a bad title rate (1 star). A second sector of the example grid corresponds to a good void rate (3 stars) and a bad title rate (1 star). A third sector of the example grid corresponds to a bad void rate (1 star) and a good title rate (3 stars). A fourth sector of the example grid corresponds to a good void rate (3 stars) and a good title rate (3 stars). A void rate of two (2) stars is represented by the approximate intersection of the boundaries of the first and second grids. A title rate of two (2) stars is represented by the approximate intersection of the boundaries of the first, second, third and forth grids. The grid of another example could plot sellers according to any criteria for which they are rated, and is not limited to void rate and/or title rate.

Sellers are grouped according to their void rate and title rate, and indicators for each group are placed at a location on the grid corresponding to the void rate and title rate of the group. In addition to plotting sellers according to their void rate and title rate, the example grid can visually present additional information. Examples of additional information include varying a size of the indicator placed on the grid according to a first parameter of the seller group or population represented by a particular performance tier, and/or varying a color of the indicator placed on the grid according to a second parameter of the seller group or population represented by a particular performance tier. For example, a size of the indicator placed on the grid can vary according to a size of the seller group or population represented by a particular performance tier (e.g., 7 sellers have 1-star void rate and a 1-star title rate, 36 sellers have a 1-star void rate and a 2-star title rate, etc.). Also, a color or shade of the indicator placed on the grid can vary according to a sales rate of the seller group or population represented by a particular performance tier (e.g., an indicator corresponding to a group having a relatively extremely high sales rate is presented using a first color, an indicator corresponding to a group having a relatively high sales rate is presented using a second color, etc.).

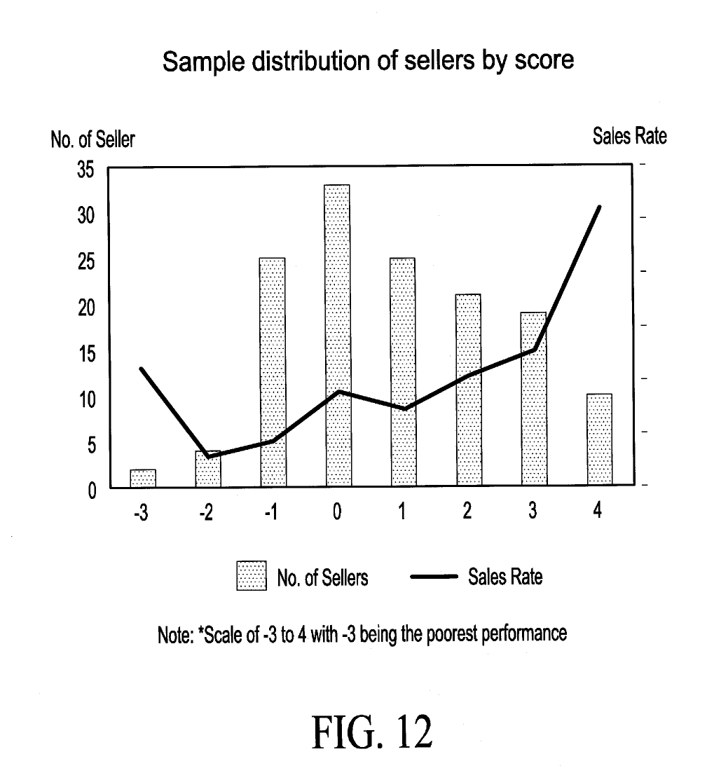

FIG. 12 is an example grid plotting a distribution of sellers according to seller score, under an embodiment. The seller score is calculated according to the seller performance, as described above, where an embodiment uses the tiers for each of sales rate, average time to transferable title (non-T/A, non-balloon), average time to transferable title (T/A or balloon note), success rate, concession rate, and outstanding A/R to calculate a seller's “score” across these five dimensions. The score is calculated for a seller using a point system that credits the seller with one (1) point for a 3-star performance tier, zero points for a 2-star performance tier, and minus one point for a 1-star performance tier. Once an individual score is determined for a seller for each of sales rate, average time to transferable title (non-T/A, non-balloon), average time to transferable title (T/A or balloon note), success rate, concession rate, and outstanding A/R, the individual scores are summed to produce an overall score, referred to as the Seller Rating Score, for the seller. The distribution of sellers of this example plots the Seller Rating Score (x-axis) versus the number of sellers having the same Seller Rating Score (y-axis). Also plotted on the distribution of sellers is the sales rate.

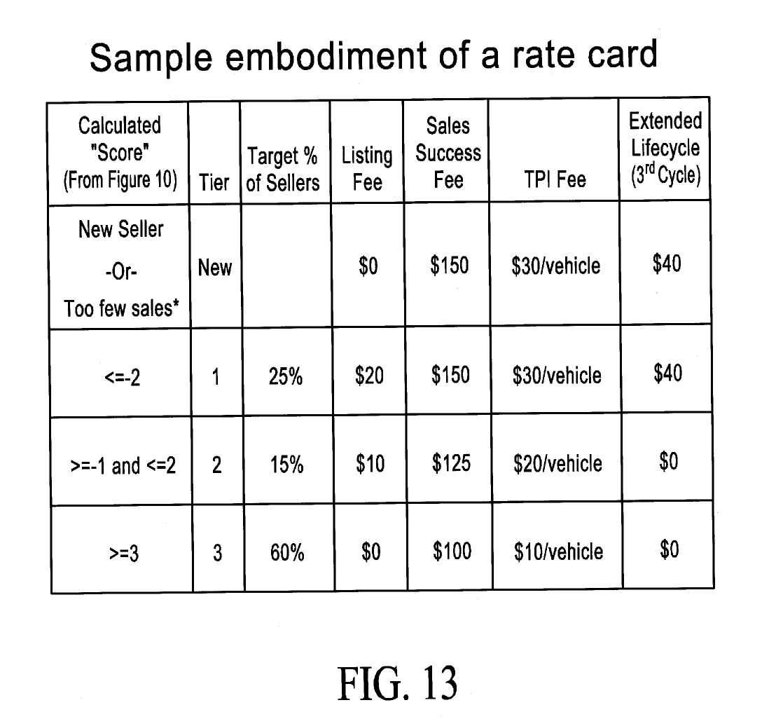

The Seller Rating Scores for sellers can be used as the basis for a fee structure for the sellers in the auction system of an embodiment. FIG. 13 is an example table showing a fee structure for sellers based on the Seller Rating Score, under an embodiment. In this example, the fees associated with sales activities through the auction system of an embodiment decrease as the seller's Seller Rating Score increases, but the embodiment is not so limited.

The seller performance data presented via the Buyer Facing Seller Performance Panel and Seller Facing Seller Performance Panel described above can be used for many purposes. As an example, the performance data of a seller can be used to market the vehicles of better performance sellers or dealers. Additionally, the performance data can be use to run promotions directed at purchasing cars from dealers having better performance metrics.

The performance data of a seller can also be used in the system of an embodiment to impact the sequence of the search results. For example, if a user searches for a Make and Model of a vehicle (i.e., BMW X6), and there are two sellers of that type of vehicle, the system of an embodiment sorts the seller having the relatively higher performance statistics first.

Furthermore, the performance data of a seller can also be used in the system of an embodiment to modify the search parameters to allow users to search dealers according to performance statistics. For example, users can specify that they only want to be presented sellers with a performance statistic better than two (2) stars in any/each category.

Embodiments described herein include a method running under a processor, the method comprising providing an auction interface that is an interface to an auction system that is an internet-based auction system. The method of an embodiment includes providing a buyer interface as a component of the auction interface. The buyer interface presents to a plurality of buyers data of vehicles available for purchase via the auction system. The method of an embodiment includes providing a seller interface as a component of the auction interface. The seller interface presents to a plurality of sellers data of vehicles that each seller makes available for purchase via the auction system. The method of an embodiment includes providing a first seller performance panel as a component of the buyer interface. The first seller performance panel includes first seller data of a seller that corresponds to each vehicle presented for purchase on the buyer interface. The first seller data comprises performance data, successful sales data, adjusted sales data, and unwound sales data. The method of an embodiment includes providing a second seller performance panel as a component of the seller interface, and a management interface by which the seller manages at least one component of the auction system. The second seller performance panel includes second seller data of the seller. The second seller data comprises performance data of the seller for all auction activities conducted by the seller on the auction system.

Embodiments described herein include a method running under a processor, the method comprising: providing an auction interface that is an interface to an auction system that is an internet-based auction system; providing a buyer interface as a component of the auction interface, wherein the buyer interface presents to a plurality of buyers data of vehicles available for purchase via the auction system; providing a seller interface as a component of the auction interface, wherein the seller interface presents to a plurality of sellers data of vehicles that each seller makes available for purchase via the auction system; providing a first seller performance panel as a component of the buyer interface, wherein the first seller performance panel includes first seller data of a seller that corresponds to each vehicle presented for purchase on the buyer interface, wherein the first seller data comprises performance data, successful sales data, adjusted sales data, and unwound sales data; and providing a second seller performance panel as a component of the seller interface, wherein the second seller performance panel includes second seller data of the seller, wherein the second seller data comprises performance data of the seller for all auction activities conducted by the seller on the auction system, and a management interface by which the seller manages at least one component of the auction system.

The performance data of the first seller data of an embodiment comprises a time-to-title.

The time-to-title of an embodiment comprises an average number of days between a vehicle sale data and receipt of a transferable title.

The time-to-title of an embodiment includes a rating generated under one of a first rating category and a second rating category.

The first rating category of an embodiment represents a first set of vehicles that are non-title absent, non-balloon vehicles, wherein the second rating category represents a second set of vehicles that are title absent, balloon vehicles.

The performance data of the first seller data of an embodiment comprises a number of sales and a success rate.

The success rate of an embodiment is generated using a first quantity divided by a number of total sales, wherein the first quantity is generated by subtracting unwound sales that are fault of the seller from the total sales.

The adjusted sales of an embodiment data comprise an arbitration reason.

The second seller data of an embodiment comprises vehicles listed for sale according to vehicle identification number.

The vehicles of an embodiment listed for sale includes in rating data, month in which vehicle was at auction, sale date, sale price, last open price, title received date, funded date, funded amount, title data, arbitration reason, voided sale indicator, concession indicator, number of bids placed, number of unique viewers of vehicle, and number of days vehicle at auction.

The second seller data of an embodiment comprises all vehicles sold via the auction system listed by vehicle identification number.

The second seller data of an embodiment comprises seller sales rate, wherein the sales rate represents a number of vehicles sold via the auction system divided by a number of unique vehicles made available for sale via the auction system.

The second seller data of an embodiment comprises a time-to-title that includes an average number of days between a vehicle sale data and receipt of a transferable title.

The time-to-title of an embodiment includes a rating generated under one of a first rating category and a second rating category, wherein the first rating category represents a first set of vehicles that are non-title absent, non-balloon vehicles, wherein the second rating category represents a second set of vehicles that are title absent, balloon vehicles.

The second seller data of an embodiment comprises vehicles for which titles remain to be received, wherein a vehicle for which a title remains to be received include a vehicle for which a title remains to be received and a vehicle having a title that is non-transferable.

The second seller data of an embodiment comprises a success rate generated using a first quantity divided by a number of total sales, wherein the first quantity is generated by subtracting unwound sales that are fault of the seller from the total sales.

The second seller data of an embodiment comprises a concession rate that is calculated as a number of vehicles for which financial remuneration was offered to a buyer as a result of a problem attributed to the seller, divided by total sales.

The concession rate of an embodiment excludes voided sales and unwound sales.

The second seller data of an embodiment comprises accounts receivable data, wherein the accounts receivable data includes an invoice corresponding to an amount due a host of the auction system.

The at least one component of the auction system of an embodiment managed using the management interface comprises live listings, sales, pending listings, unsold vehicles, and review of bids.

The method of an embodiment comprises a first grid presented via the first seller performance panel, wherein the first grid presents sellers according to title rate and void rate.

The method of an embodiment comprises a second grid presented via the first seller performance panel, wherein the second grid presents a distribution of sellers according to seller rating score.

The method of an embodiment comprises generating the seller rating score by summing individual scores for the seller for each of sales rate, average time to transferable title, success rate, concession rate, and outstanding accounts receivable.

The method of an embodiment comprises, using the seller rating score, generating a fee structure by which fees associated with sales activities through the auction system are determined for a seller.

The fees of an embodiment associated with sales activities through the auction system decrease with an increase in the seller rating score of the seller.

Embodiments described herein include a system comprising an auction server coupled to a network and hosting an auction system on the network. The system of an embodiment includes an auction interface for accessing the auction system. The system of an embodiment includes a buyer interface that is a component of the auction interface. The buyer interface presents to a plurality of buyers data of vehicles available for purchase via the auction system. The system of an embodiment includes a seller interface that is a component of the auction interface. The seller interface presents to a plurality of sellers data of vehicles that each seller makes available for purchase via the auction system. The system of an embodiment includes a first seller performance panel of the buyer interface. The first seller performance panel includes first seller data of a seller that corresponds to each vehicle presented for purchase on the buyer interface. The first seller data comprises performance data, successful sales data, adjusted sales data, and unwound sales data. The system of an embodiment includes a second seller performance panel of the seller interface, and a management interface by which the seller manages at least one component of the auction system. The second seller performance panel includes second seller data of the seller. The second seller data comprises performance data of the seller for all auction activities conducted by the seller on the auction system.

Embodiments described herein include a system comprising: an auction server coupled to a network and hosting an auction system on the network; an auction interface for accessing the auction system; a buyer interface that is a component of the auction interface, wherein the buyer interface presents to a plurality of buyers data of vehicles available for purchase via the auction system; a seller interface that is a component of the auction interface, wherein the seller interface presents to a plurality of sellers data of vehicles that each seller makes available for purchase via the auction system; a first seller performance panel of the buyer interface, wherein the first seller performance panel includes first seller data of a seller that corresponds to each vehicle presented for purchase on the buyer interface, wherein the first seller data comprises performance data, successful sales data, adjusted sales data, and unwound sales data; and a second seller performance panel of the seller interface, wherein the second seller performance panel includes second seller data of the seller, wherein the second seller data comprises performance data of the seller for all auction activities conducted by the seller on the auction system, and a management interface by which the seller manages at least one component of the auction system.

The performance data of the first seller data of an embodiment comprises a time-to-title.

The time-to-title of an embodiment comprises an average number of days between a vehicle sale data and receipt of a transferable title.

The time-to-title of an embodiment includes a rating generated under one of a first rating category and a second rating category.

The first rating category of an embodiment represents a first set of vehicles that are non-title absent, non-balloon vehicles, wherein the second rating category represents a second set of vehicles that are title absent, balloon vehicles.

The performance data of the first seller data of an embodiment comprises a number of sales and a success rate.

The success rate of an embodiment is generated using a first quantity divided by a number of total sales, wherein the first quantity is generated by subtracting unwound sales that are fault of the seller from the total sales.

The adjusted sales data of an embodiment comprises an arbitration reason.

The second seller data of an embodiment comprises vehicles listed for sale according to vehicle identification number.

The vehicles of an embodiment listed for sale includes in rating data, month in which vehicle was at auction, sale date, sale price, last open price, title received date, funded date, funded amount, title data, arbitration reason, voided sale indicator, concession indicator, number of bids placed, number of unique viewers of vehicle, and number of days vehicle at auction.

The second seller data of an embodiment comprises all vehicles sold via the auction system listed by vehicle identification number.

The second seller data of an embodiment comprises seller sales rate, wherein the sales rate represents a number of vehicles sold via the auction system divided by a number of unique vehicles made available for sale via the auction system.

The second seller data of an embodiment comprises a time-to-title that includes an average number of days between a vehicle sale data and receipt of a transferable title.

The time-to-title of an embodiment includes a rating generated under one of a first rating category and a second rating category, wherein the first rating category represents a first set of vehicles that are non-title absent, non-balloon vehicles, wherein the second rating category represents a second set of vehicles that are title absent, balloon vehicles.

The second seller data of an embodiment comprises vehicles for which titles remain to be received, wherein a vehicle for which a title remains to be received include a vehicle for which a title remains to be received and a vehicle having a title that is non-transferable.

The second seller data of an embodiment comprises a success rate generated using a first quantity divided by a number of total sales, wherein the first quantity is generated by subtracting unwound sales that are fault of the seller from the total sales.

The second seller data of an embodiment comprises a concession rate that is calculated as a number of vehicles for which financial remuneration was offered to a buyer as a result of a problem attributed to the seller, divided by total sales.

The concession rate of an embodiment excludes voided sales and unwound sales.

The second seller data of an embodiment comprises accounts receivable data, wherein the accounts receivable data includes an invoice corresponding to an amount due a host of the auction system.

The at least one component of the auction system of an embodiment managed using the management interface comprises live listings, sales, pending listings, unsold vehicles, and review of bids.

The system of an embodiment comprises a first grid presented via the first seller performance panel, wherein the first grid presents sellers according to title rate and void rate.

The system of an embodiment comprises a second grid presented via the first seller performance panel, wherein the second grid presents a distribution of sellers according to seller rating score.

The seller rating score of an embodiment is generated by summing individual scores for the seller for each of sales rate, average time to transferable title, success rate, concession rate, and outstanding accounts receivable.

A fee structure of an embodiment is generated, using the seller rating score, by which fees associated with sales activities through the auction system are determined for a seller.

The fees of an embodiment associated with sales activities through the auction system decrease with an increase in the seller rating score of the seller.

The systems and methods described herein include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of a host system, and/or provided by some combination of algorithms. The methods described herein can be implemented in one or more of software algorithm(s), programs, firmware, hardware, components, circuitry, in any combination.

System components embodying the systems and methods described herein can be located together or in separate locations. Consequently, system components embodying the systems and methods described herein can be components of a single system, multiple systems, and/or geographically separate systems. These components can also be subcomponents or subsystems of a single system, multiple systems, and/or geographically separate systems. These components can be coupled to one or more other components of a host system or a system coupled to the host system.

Communication paths couple the system components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments is not intended to be exhaustive or to limit the systems and methods described to the precise form disclosed. While specific embodiments and examples are described herein for illustrative purposes, various equivalent modifications are possible within the scope of other systems and methods, as those skilled in the relevant art will recognize. The teachings provided herein can be applied to other processing systems and methods, not only for the systems and methods described above.

The elements and acts of the various embodiments described above can be combined to provide further embodiments. These and other changes can be made to the embodiments in light of the above detailed description.

In general, in the following claims, the terms used should not be construed to limit the systems and methods to the specific embodiments disclosed in the specification and the claims, but should be construed to include all systems that operate under the claims. Accordingly, the systems and methods are not limited by the disclosure, but instead the scope is to be determined entirely by the claims.

While certain aspects of the systems and methods are presented below in certain claim forms, the inventors contemplate the various aspects of the systems and methods in any number of claim forms. Accordingly, the inventors reserve the right to add additional claims after filing the application to pursue such additional claim forms for other aspects of the systems and methods.

What is claimed is:

1. A method running under a processor, the method comprising:
providing an auction interface that is an interface to an auction system that is an internet-based auction system;
providing a buyer interface as a component of the auction interface, wherein the buyer interface presents to a plurality of buyers data of vehicles available for purchase via the auction system;
providing a seller interface as a component of the auction interface, wherein the seller interface presents to a plurality of sellers data of vehicles that each seller makes available for purchase via the auction system;
providing a first seller performance panel as a component of the buyer interface, wherein the first seller performance panel includes first seller data of a seller that corresponds to each vehicle presented for purchase on the buyer interface, wherein the first seller data comprises performance data, successful sales data, adjusted sales data, and unwound sales data; and
providing a second seller performance panel as a component of the seller interface, wherein the second seller performance panel includes second seller data of the seller, wherein the second seller data comprises performance data of the seller for all auction activities conducted by the seller on the auction system, and a management interface by which the seller manages at least one component of the auction system.

2. The method of claim 1, wherein the performance data of the first seller data comprises a time-to-title.

3. The method of claim 2, wherein the time-to-title comprises an average number of days between a vehicle sale data and receipt of a transferable title.

4. The method of claim 2, wherein the time-to-title includes a rating generated under one of a first rating category and a second rating category.

5. The method of claim 4, wherein the first rating category represents a first set of vehicles that are non-title absent, non-balloon vehicles, wherein the second rating category represents a second set of vehicles that are title absent, balloon vehicles.

6. The method of claim 2, wherein the performance data of the first seller data comprises a number of sales and a success rate.

7. The method of claim 6, wherein the success rate is generated using a first quantity divided by a number of total sales, wherein the first quantity is generated by subtracting unwound sales that are fault of the seller from the total sales.

8. The method of claim 1, wherein the adjusted sales data comprises an arbitration reason.

9. The method of claim 1, wherein the second seller data comprises vehicles listed for sale according to vehicle identification number.

10. The method of claim 9, wherein the vehicles listed for sale includes in rating data, month in which vehicle was at auction, sale date, sale price, last open price, title received date, funded date, funded amount, title data, arbitration reason, voided sale indicator, concession indicator, number of bids placed, number of unique viewers of vehicle, and number of days vehicle at auction.

11. The method of claim 1, wherein the second seller data comprises all vehicles sold via the auction system listed by vehicle identification number.

12. The method of claim 1, wherein the second seller data comprises seller sales rate, wherein the sales rate represents a number of vehicles sold via the auction system divided by a number of unique vehicles made available for sale via the auction system.

13. The method of claim 1, wherein the second seller data comprises a time-to-title that includes an average number of days between a vehicle sale data and receipt of a transferable title.

14. The method of claim 13, wherein the time-to-title includes a rating generated under one of a first rating category and a second rating category, wherein the first rating category represents a first set of vehicles that are non-title absent, non-balloon vehicles, wherein the second rating category represents a second set of vehicles that are title absent, balloon vehicles.

15. The method of claim 1, wherein the second seller data comprises vehicles for which titles remain to be received, wherein a vehicle for which a title remains to be received include a vehicle for which a title remains to be received and a vehicle having a title that is non-transferable.

16. The method of claim 1, wherein the second seller data comprises a success rate generated using a first quantity divided by a number of total sales, wherein the first quantity is generated by subtracting unwound sales that are fault of the seller from the total sales.

17. The method of claim 1, wherein the second seller data comprises a concession rate that is calculated as a number of vehicles for which financial remuneration was offered to a buyer as a result of a problem attributed to the seller, divided by total sales.

18. The method of claim 1, wherein the concession rate excludes voided sales and unwound sales.

19. The method of claim 1, wherein the second seller data comprises accounts receivable data, wherein the accounts receivable data includes an invoice corresponding to an amount due a host of the auction system.

20. The method of claim 1, wherein the at least one component of the auction system managed using the management interface comprises live listings, sales, pending listings, unsold vehicles, and review of bids.

21. The method of claim 1, comprising a first grid presented via the first seller performance panel, wherein the first grid presents sellers according to title rate and void rate.

22. The method of claim 1, comprising a second grid presented via the first seller performance panel, wherein the second grid presents a distribution of sellers according to seller rating score.

23. The method of claim 22, comprising generating the seller rating score by summing individual scores for the seller for each of sales rate, average time to transferable title, success rate, concession rate, and outstanding accounts receivable.

24. The method of claim 1, comprising, using the seller rating score, generating a fee structure by which fees associated with sales activities through the auction system are determined for a seller.

25. The method of claim 24, wherein the fees associated with sales activities through the auction system decrease with an increase in the seller rating score of the seller.

26. A system comprising:
an auction server coupled to a network and hosting an auction system on the network;
an auction interface for accessing the auction system;
a buyer interface that is a component of the auction interface, wherein the buyer interface presents to a plurality of buyers data of vehicles available for purchase via the auction system;
a seller interface that is a component of the auction interface, wherein the seller interface presents to a plurality of sellers data of vehicles that each seller makes available for purchase via the auction system;
a first seller performance panel of the buyer interface, wherein the first seller performance panel includes first seller data of a seller that corresponds to each vehicle presented for purchase on the buyer interface, wherein the first seller data comprises performance data, successful sales data, adjusted sales data, and unwound sales data; and
a second seller performance panel of the seller interface, wherein the second seller performance panel includes second seller data of the seller, wherein the second seller data comprises performance data of the seller for all auction activities conducted by the seller on the auction system, and a management interface by which the seller manages at least one component of the auction system.

27. The system of claim 26, wherein the performance data of the first seller data comprises a time-to-title.

28. The system of claim 27, wherein the time-to-title comprises an average number of days between a vehicle sale data and receipt of a transferable title.

29. The system of claim 27, wherein the time-to-title includes a rating generated under one of a first rating category and a second rating category.

30. The system of claim 29, wherein the first rating category represents a first set of vehicles that are non-title absent, non-balloon vehicles, wherein the second rating category represents a second set of vehicles that are title absent, balloon vehicles.

31. The system of claim 27, wherein the performance data of the first seller data comprises a number of sales and a success rate.

32. The system of claim 31, wherein the success rate is generated using a first quantity divided by a number of total sales, wherein the first quantity is generated by subtracting unwound sales that are fault of the seller from the total sales.

33. The system of claim 26, wherein the adjusted sales data comprises an arbitration reason.

34. The system of claim 26, wherein the second seller data comprises vehicles listed for sale according to vehicle identification number.

35. The system of claim 34, wherein the vehicles listed for sale includes in rating data, month in which vehicle was at auction, sale date, sale price, last open price, title received date, funded date, funded amount, title data, arbitration reason, voided sale indicator, concession indicator, number of bids placed, number of unique viewers of vehicle, and number of days vehicle at auction.

36. The system of claim 26, wherein the second seller data comprises all vehicles sold via the auction system listed by vehicle identification number.

37. The system of claim 26, wherein the second seller data comprises seller sales rate, wherein the sales rate represents a number of vehicles sold via the auction system divided by a number of unique vehicles made available for sale via the auction system.

38. The system of claim 26, wherein the second seller data comprises a time-to-title that includes an average number of days between a vehicle sale data and receipt of a transferable title.

39. The system of claim 38, wherein the time-to-title includes a rating generated under one of a first rating category and a second rating category, wherein the first rating category represents a first set of vehicles that are non-title absent, non-balloon vehicles, wherein the second rating category represents a second set of vehicles that are title absent, balloon vehicles.

40. The system of claim 26, wherein the second seller data comprises vehicles for which titles remain to be received, wherein a vehicle for which a title remains to be received include a vehicle for which a title remains to be received and a vehicle having a title that is non-transferable.

41. The system of claim 26, wherein the second seller data comprises a success rate generated using a first quantity divided by a number of total sales, wherein the first quantity is generated by subtracting unwound sales that are fault of the seller from the total sales.

42. The system of claim 26, wherein the second seller data comprises a concession rate that is calculated as a number of vehicles for which financial remuneration was offered to a buyer as a result of a problem attributed to the seller, divided by total sales.

43. The system of claim 26, wherein the concession rate excludes voided sales and unwound sales.

44. The system of claim 26, wherein the second seller data comprises accounts receivable data, wherein the accounts receivable data includes an invoice corresponding to an amount due a host of the auction system.

45. The system of claim 26, wherein the at least one component of the auction system managed using the management interface comprises live listings, sales, pending listings, unsold vehicles, and review of bids.

46. The system of claim 26, comprising a first grid presented via the first seller performance panel, wherein the first grid presents sellers according to title rate and void rate.

47. The system of claim 26, comprising a second grid presented via the first seller performance panel, wherein the second grid presents a distribution of sellers according to seller rating score.

48. The system of claim 47, wherein the seller rating score is generated by summing individual scores for the seller for each of sales rate, average time to transferable title, success rate, concession rate, and outstanding accounts receivable.

49. The system of claim 26, wherein a fee structure is generated, using the seller rating score, by which fees associated with sales activities through the auction system are determined for a seller.

50. The system of claim 49, wherein the fees associated with sales activities through the auction system decrease with an increase in the seller rating score of the seller.
